(19) United States
(12) Patent Application Publication
(10) Pub. No.: US 2010/0079535 A1
(43) Pub. Date: Apr. 1, 2010

(54) INSPECTION DEVICE FOR LIQUID EJECTING HEAD

(75) Inventors: Tomohiro SAYAMA, Matsumoto-shi (JP); Tomoaki TAKAHASHI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/568,194

(22) Filed: Sep. 28, 2009

(30) Foreign Application Priority Data
Sep. 29, 2008 (JP) 2008-249906

(51) Int. Cl. B41J 29/393; B41J 2/045

(52) U.S. Cl. 347/19; 347/70

(57) ABSTRACT

Provided is an inspection device for a liquid ejecting head including: a first vibration plate which is positioned at a position opposite to the nozzle openings of the liquid ejecting head for ejecting a liquid from the nozzle openings such that the liquid ejected from the nozzle openings of the liquid ejecting head lands thereon; a first piezoelectric element bonded to the first vibration plate; and a detecting unit which is connected to the first piezoelectric element so as to detect an electrical variation in the first piezoelectric element, wherein the detecting unit inspects the ejection state of the nozzle openings based on a voltage variation in the first piezoelectric element by the liquid landing onto the first vibration plate.

Japanese Patent Application No. 2008-249906, filed on Sep. 29, 2008, is incorporated by reference in its entirely.

### BACKGROUND

1. Technical Field

The present invention relates to an inspection device for a liquid ejecting head, which inspects a landing state of a liquid ejected from nozzle openings of the liquid ejecting head such as an ink jet recording head.

2. Related Art

Examples of a liquid ejecting head for ejecting (jetting) liquid droplets from nozzle openings by generating a pressure variation in a liquid in a pressure chamber include: an ink jet recording head (hereinafter, referred to as a recording head) used in an image recording device such as an ink jet recording device (hereinafter, referred to as a printer); a color material ejecting head used for manufacturing color filters of a liquid crystal display and the like; an electrode material ejecting head used for forming electrodes of an organic Electro Luminescence (EL) display; a Field Emission Display (FED) and the like; a bio-organic matter ejecting head used for manufacturing biochips, and the like.

For example, in the recording head, if the ink (liquid) is not ejected from any one of a plurality of nozzle openings due to thickening and adhesion of a liquid exposed through the nozzle openings caused by natural evaporation or pressure loss due to air bubbles mixed into the liquid in the pressure chamber, that is, if so-called dot dropout occurs, an image of the recording medium (ejection object) is not correctly printed. Accordingly, a technology of inspecting whether or not the ink is ejected from the nozzle openings with certainty has been suggested. As a method of detecting dot dropout, for example, JP-A-2008-168526 discloses a technology of inspecting whether or not the ink is ejected, by charging an ink, flying the ink between electrodes, and detecting a voltage variation between electrodes.

However, in the above technology, since the ink is detected using electrical characteristics, it is difficult to detect a non-conductive ink droplet (liquid) such as a UV ink. Accordingly, the kind of the liquid ejected from the liquid ejecting head is restricted.

### SUMMARY

An advantage of some aspects of the invention is that it provides an inspection device for a liquid ejecting head, which is capable of inspecting the landing of an ejected liquid regardless of the electrical property of the liquid.

According to an aspect of the invention, there is provided an inspection device for a liquid ejecting head including: a first vibration plate which is positioned at a position opposite to the nozzle openings of the liquid ejecting head for ejecting a liquid from the nozzle openings such that the liquid ejected from the nozzle openings of the liquid ejecting head lands thereon; a first piezoelectric element bonded to the first vibration plate; and a detecting unit which is connected to the first piezoelectric element so as to detect an electrical variation of the first piezoelectric element, wherein the detecting unit inspects the ejection state of the nozzle openings based on a voltage variation of the first piezoelectric element by the landing of the liquid onto the first vibration plate.

According to the above configuration, since the inspection device for a liquid ejecting head includes the first vibration plate which is positioned at the position opposite to the nozzle openings of the liquid ejecting head for ejecting the liquid from the nozzle openings such that the liquid ejected from the nozzle openings of the liquid ejecting head lands thereon, the first piezoelectric element bonded to the first vibration plate; and the detecting unit which is connected to the first piezoelectric element so as to detect an electrical variation of the first piezoelectric element, and the detecting unit inspects the ejection state of the nozzle openings based on the voltage variation of the first piezoelectric element by the landing of the liquid onto the first vibration plate, the vibration plate is vertically vibrated when the liquid ejected from the nozzle openings of the liquid ejecting head lands on the first vibration plate, and thus a voltage is generated from the deformed first piezoelectric element. Accordingly, the voltage generated from the first piezoelectric element is detected by the detecting unit such that the ejection failure of the nozzle openings can be inspected. Therefore, it is possible to perform the dot dropout detection of the liquid ejecting head regardless of the electrical property of the liquid.

In the above configuration, the liquid ejecting head may include a second vibration plate partitioning at least a portion of the pressure generation chambers communicating with the nozzle openings and a second piezoelectric element bonded to the second vibration plate, the first vibration plate may be configured by a vibration plate having the same structure as the second vibration plate, and the first piezoelectric element may be configured by a piezoelectric element having the same structure as the second piezoelectric element.

According to the above configuration, since the liquid ejecting head includes the second vibration plate partitioning at least a portion of the pressure generation chambers communicating with the nozzle openings and the second piezoelectric element bonded to the second vibration plate, the first vibration plate is configured by a vibration plate having the same structure as the second vibration plate, and the first piezoelectric element is configured by a piezoelectric element having the same structure as the second piezoelectric element, the same components as the vibration plate and the piezoelectric element of the liquid ejecting head can be used in the inspection device for the liquid ejecting head. Therefore, it is possible to easily manufacture the inspection device for the liquid ejecting head at a low cost.

In the above configuration, the liquid ejecting head may be configured such that a first liquid and a second liquid, with a residue during drying less than that of the first liquid, are ejected toward the first vibration plate, and the first liquid may be ejected after the second liquid is ejected toward the first vibration plate such that the landing state of the first liquid is detected by the detecting unit.

According to the above configuration, since the liquid ejecting head is configured such that a first liquid and a second liquid, with a residue during drying less than that of the first liquid, are ejected toward the first vibration plate, and the first liquid is ejected after the second liquid is ejected toward the first vibration plate such that the landing state of the first liquid is detected by the detecting unit, it is possible to suppress the reduction in the detection accuracy of the liquid by detecting the landing of the first liquid after the first vibration plate is cleaned by the second liquid.

In the above configuration, the liquid ejecting head may be configured such that a first liquid and a second liquid, with a residue during drying less than that of the first liquid, are ejected toward the first vibration plate, and the second liquid may be ejected after the first liquid is ejected such that the landing state of the second liquid is detected by the detecting unit.

According to the above configuration, since the liquid ejecting head is configured such that the first liquid and the second liquid, with the residue during drying less than that of the first liquid, are ejected toward the first vibration plate, and the second liquid may be ejected after the first liquid is ejected such that the landing state of the second liquid is detected by the detecting unit, it is possible to suppress the reduction of the detection accuracy of the liquid by adhering the residue included in the liquid to the first vibration plate.

In the above configuration, the liquid ejecting head may eject the liquid at a time interval being an integral multiple of an inherent vibration period of the first vibration plate and the first piezoelectric element.

According to the above configuration, since the liquid ejecting head ejects the liquid at a time interval being the integral multiple of the inherent vibration period of the first vibration plate and the first piezoelectric element, it is possible to amplify the amplitude of the first vibration plate and improve the inspection accuracy of the liquid.

In the above configuration, the detecting unit may perform detection based on an average value of a voltage within a predetermined time while the liquid is ejected from the liquid ejecting head.

According to the above configuration, since the detection is performed based on the average value of the voltage within the predetermined time while the liquid is ejected from the liquid ejecting head, it is possible to improve the reliability of the inspection of the ejection of the liquid.

### BRIEF DESCRIPTION OF THE DRAWINGS

The invention will be described with reference to the accompanying drawings, wherein like numbers reference like elements.

FIG. 1 is a perspective view of a printer.

FIG. 2 is a cross-sectional view explaining the configuration of a recording head and an inspection device for a liquid ejecting head.

FIG. 3 is a cross-sectional view taken along line III-III of FIG. 2.

FIG. 4 is an explanatory view explaining a state in which an ink lands on a vibration plate of the inspection device for the liquid ejecting head.

FIG. 5 is a view showing a voltage variation in a voltage detecting circuit.

FIG. 6 is a view showing a value obtained by A/D converting the voltage variation of FIG. 5.

FIG. 7 is a plan view of a nozzle plate.

FIG. 8 is an explanatory view explaining the positioning of the nozzle plate and the vibration plate.

### DESCRIPTION OF EXEMPLARY EMBODIMENTS

Hereinafter, embodiments of the invention will be described with reference to the accompanying drawings. Note that, in the embodiments described below, various limitations are made as desirable specific embodiments of the invention; however, the scope of the invention is not intended to be limited to these embodiments. In addition, in the following description, an ink jet recording device (hereinafter, simply referred to as a printer) in which an ink jet recording head (hereinafter, referred to as a “recording head”) is used as an example of a liquid ejecting head which is an object to be inspected of the invention is exemplified as a representative liquid ejecting apparatus.

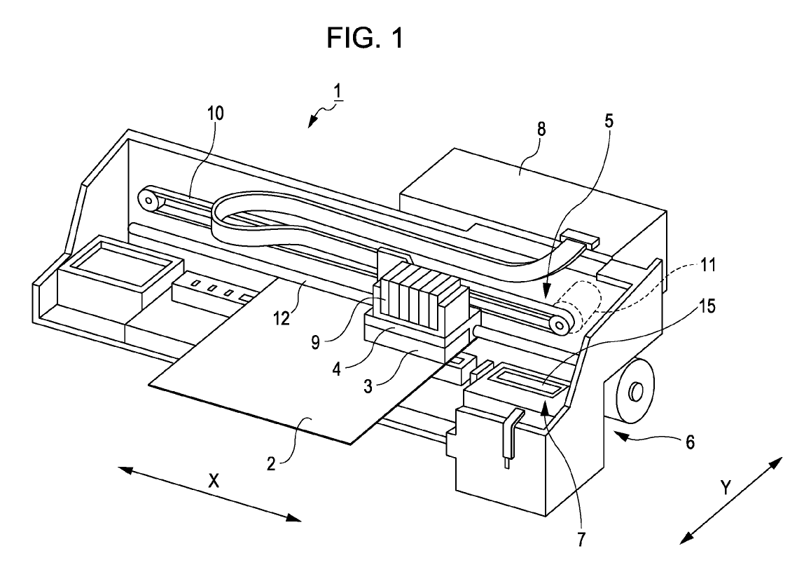

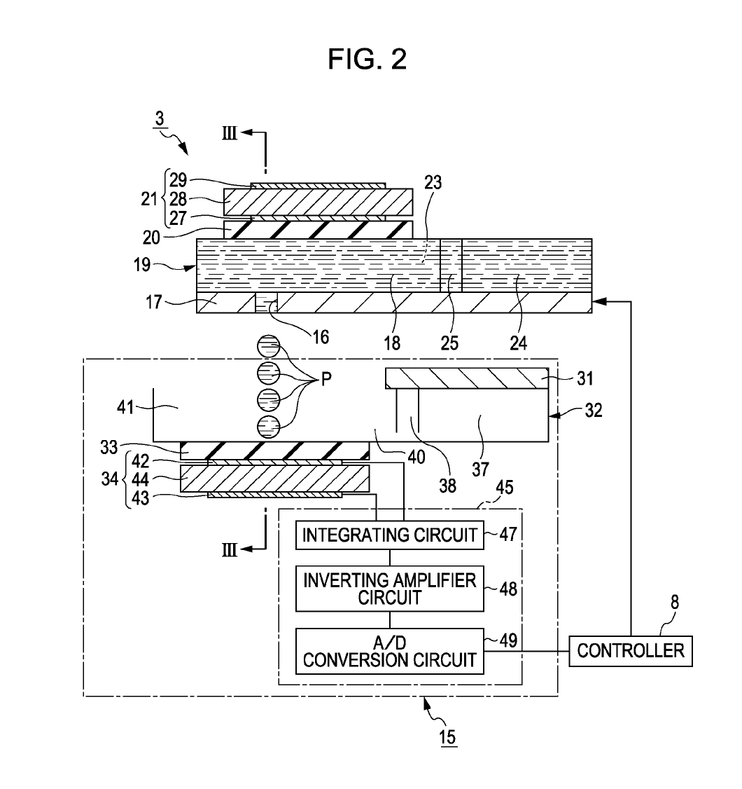

FIG. 1 is a perspective view of a printer 1. First, the schematic configuration of the printer 1 in which a recording head 3 is mounted will be described with reference to FIG. 1. The exemplified printer 1 is a device for ejecting a liquid ink (an ejected ink is an ink droplet denoted by a reference numeral P in FIG. 2) onto the surface of a recording medium (a landing object) 2 such as recording paper so as to record an image, or the like.

The printer 1 includes the recording head 3 (corresponding to a kind of liquid ejecting head of the invention) for ejecting (jetting) an ink droplet P, a carriage 4 in which the recording head 3 is mounted, a carriage movement mechanism 5 for moving the carriage 4 in a main scanning direction (denoted by a reference numeral X in FIG. 1), a paper transport mechanism 6 for transporting the recording medium 2 in a sub scanning direction (a direction perpendicular to the main scanning direction, which is denoted by a reference numeral Y in FIG. 1), a capping mechanism 7 provided at a home position of a non-recording region of the printer 1, and a controller 8 for controlling the overall printer 1. The ink is a kind of liquid of the invention and is stored in an ink cartridge 9. This ink cartridge 9 individually receive inks of, for example, yellow (Y), light magenta (LM), magenta (M), light cyan (LC), cyan (C) and black (BK), and is detachably mounted in the recording head 3.

The carriage movement mechanism 5 includes a timing belt 10 connected to the carriage 4. This timing belt 10 is driven by a plus motor 11 such as a DC motor. Accordingly, if the plus motor 11 is operated, the carriage 4 is guided to a guide rod 12 installed in the printer 1 and is reciprocally moved in the main scanning direction X (the width direction of the recording medium 2).

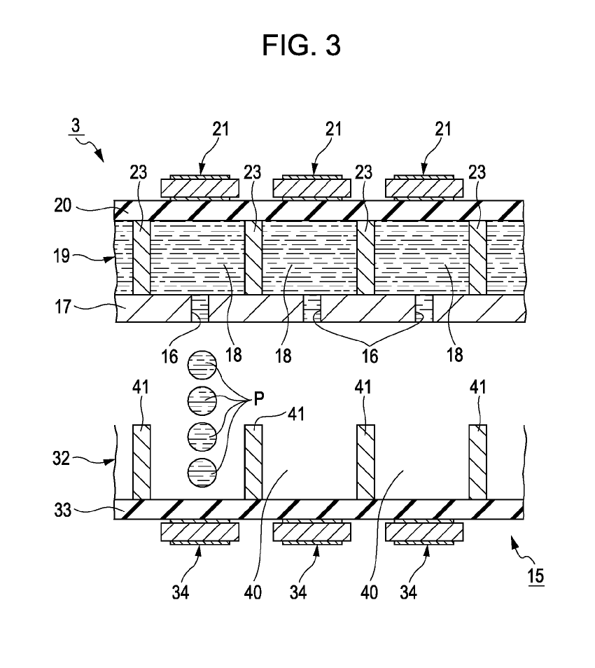

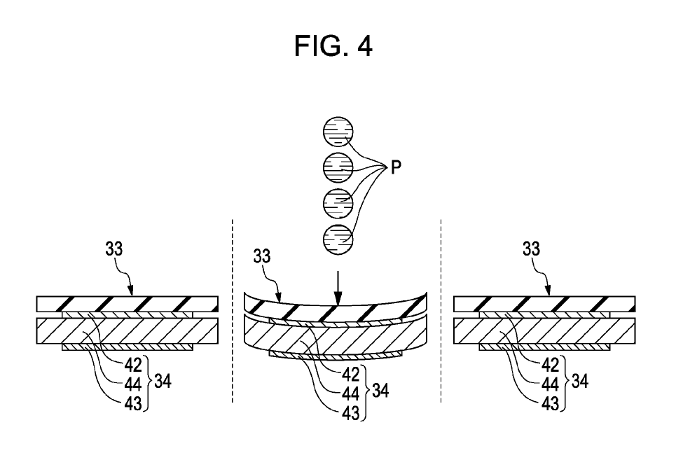

FIG. 2 is a cross-sectional view explaining the configuration of the recording head 3 and a inspection device 15 for the liquid ejecting head, and FIG. 3 is a cross-sectional view taken along line III-III of FIG. 2. The recording head 3 is configured by laminating a nozzle plate 17 in which nozzle openings 16 are formed, a flow channel forming substrate 19 in which an ink flow channel including pressure generation chambers 18 communicating with the nozzle openings 16 is formed, a flexible vibration plate 20 (corresponding to a second vibration plate) for sealing the openings of the pressure generation chambers 18, piezoelectric elements 21 (corresponding to a second piezoelectric element) bonded to the upper surface of the vibration plate 20, and the like.

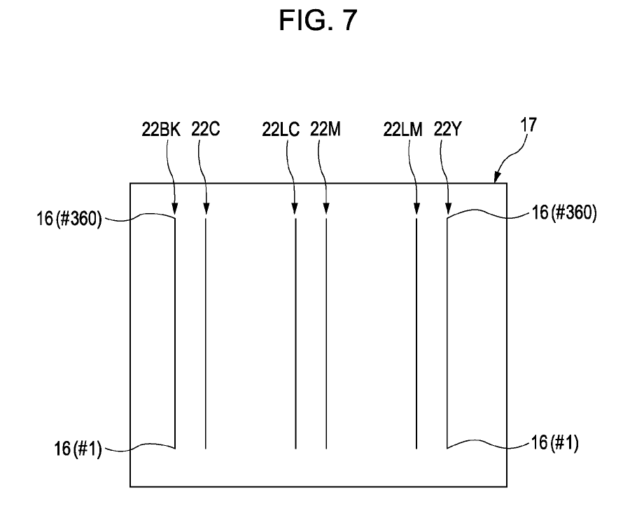

Nozzle arrays 22 (see FIG. 7), in which a plurality (360, in the present embodiment) of nozzle openings 16 for ejecting the ink droplets P is arranged along the sub scanning direction Y, are formed in the nozzle plate 17. As the nozzle arrays 22, a total of 6 arrays (22Y, 22LM, 22M, 22LC, 22C and 22BK) corresponding to the respective colors of yellow (Y), light magenta (LM), magenta (M), light cyan (LC), cyan (C) and black (BK) are arranged in the main scanning direction X. In addition, the nozzle plate 17 has, for example, a thickness of 0.01 to 1 mm, a linear expansion coefficient of 300° C. or less, and is formed of, for example, glass ceramics of 2.5 to 4.5 [×10⁻⁶/° C.], a silicon monocrystal substrate or stainless steel.

In the present embodiment, the flow channel forming substrate 19 is formed of a silicon monocrystal substrate of plane orientation (110) and a plurality of pressure generation chambers 18 is arranged in the flow channel forming substrate 19 with partition walls 22 in the width direction thereof. A reservoir 24 is formed in the lengthwise direction outside the pressure generation chambers 18 of the flow channel forming substrate 19, and the reservoir 24 and the pressure generation chambers 18 communicate with each other through ink supply paths 25 respectively provided in the pressure generation chambers 18. The ink supply paths 25 are formed with a width narrower than that of the pressure generation chambers 18, and the flow channel resistance of the ink flowing from the reservoir 24 into the pressure generation chambers 18 is kept constant. In addition, the nozzle plate 17 is bonded to one opened surface side of the flow channel forming substrate 19 by an adhesive, a hot welded film or the like, and the nozzle openings 16 are positioned in the end of the pressure generation chambers 18 on the side opposite to the ink supply paths 25.

The vibration plate 20 includes an elastic film formed of silicon dioxide (SiO₂) with a thickness of, for example, about 1.0 μm and an insulating film formed on the elastic film and formed of zirconium oxide (ZrO₂) with a thickness of, for example, about 0.4 μm. The vibration plate 20 is arranged such that the elastic film side thereof is bonded to the opened surface side of the flow channel forming substrate 19 on the side opposite to the nozzle plate 17, and partitions the other openings of the pressure generation chambers 18.

A lower electrode film 27 (lower electrode) having a thickness of, for example, about 0.2 μm, a piezoelectric layer 28 having a thickness of, for example, about 1.0 μm, and an upper electrode film 29 (upper electrode) having a thickness of, for example, about 0.05 μm are sequentially formed on the vibration plate 20 in a lamination shape so as to configure each of the piezoelectric elements 21 having a total thickness of about 1.25 μm. In general, any one electrode of each of the piezoelectric elements 21 is a common electrode and the other electrode and the piezoelectric layer 28 are patterned in each of the pressure generation chambers 18. A portion which is configured by any one patterned electrode and the piezoelectric layer 28 and in which piezoelectric distortion occurs by applying a voltage between both electrodes is called a piezoelectric active portion. Although, in the present embodiment, the lower electrode film 27 is the common electrode of each of the piezoelectric elements 21 and the upper electrode film 29 is the individual electrode of each of the piezoelectric elements 21, the opposite configuration thereof may be realized according to the situation of a driving circuit or a wire. In either case, the piezoelectric active portion is formed in each of the pressure generation chambers 18. For example, a lead electrode (not shown) formed of gold (Au), or the like, is connected to the upper electrode film 29 of each of the piezoelectric elements 21, and a voltage is selectively applied to each of the piezoelectric elements 21 through this lead electrode.

In the recording head 3 having the above configuration, the inks of the respective colors are captured from the ink cartridge 9, the inks are filled from the reservoir 24 from the nozzle openings 16 of the respective colors, and a driving signal is supplied from a controller 8 such that the voltage is applied between the lower electrode film 27 and the upper electrode film 29 corresponding to each of the pressure generation chambers 18, and the vibration plate 20, the lower electrode film 27 and the piezoelectric layer 28 is flexibly deformed such that the pressure of each of the pressure generation chambers 18 is increased, and a pressure variation is controlled such that the ink droplets P are ejected (jetted) from the nozzle openings 16.

Next, the inspection device 15 for the liquid ejecting head, which inspects the landing of the ink droplets P ejected from the nozzle openings 16 of the recording head 3, will be described. The inspection device 15 for the liquid ejecting head according to the invention has substantially the same configuration as the configuration of the recording head 3 of an object to be inspected, and, in detail, has the configuration in which the vibration plate 20 is exposed excluding the nozzle plate 17 of the portions for sealing the pressure generation chambers 18 of the recording head 3. The inspection device 15 for the liquid ejecting head may be an independent device for inspecting the recording head 3 assembled by a process of manufacturing the recording head 3 or may be mounted in the printer 1, or the like. Hereinafter, an embodiment in which the inspection device is mounted in the printer 1 will be described. The inspection device 15 for the liquid ejecting head is positioned at the home position, and includes, as shown in FIGS. 2 and 3, an upper plate 31, a flow channel forming substrate 32 having the same structure as the flow channel forming substrate 19 of the recording head 3, a vibration plate 33 (corresponding to a first vibration plate) having the same structure as the vibration plate 20 of the recording head 3, and a piezoelectric element 34 (corresponding to a first piezoelectric element) having the same structure as the piezoelectric element 21 of the recording head 3, all of which are laminated in this order.

The upper plate 31 has the same configuration as the remaining portion excluding the portion for sealing a pressure generation chamber 36 of the nozzle plate 17 of the recording head 3, and is bonded in a region extending from a reservoir 37 of one opened surface side of the flow channel forming substrate 32 to an ink recovery path 38 by an adhesive, a hot welded film, or the like. In addition, a plurality of opened chambers 40 is arranged in the flow channel forming substrate 32 with partition walls 41 in the width direction thereof, similar to the pressure generation chambers 18 of the recording head 3. Accordingly, the upper plate 31 seals (partitions) the reservoir 37 and the ink recovery path 38 and opens the upper surface of the opened chambers 40 so as to expose the vibration plate 33 for sealing the opening on the opposite side of the upper plate 31 between the partition walls 41 as the bottom of the opened chambers 40. In addition, the ink which lands and is reserved on the vibration plate 33 is discharged from the ink recovery path 38 through the reservoir 37.

The piezoelectric element 34 is bonded to the lower surface of the vibration plate 33 on the opposite side of the opened chambers 40, the piezoelectric element 34 includes a lower electrode film 42, a piezoelectric layer 44 and an upper electrode film 43, all of which are sequentially laminated from the vibration plate 33, similar to the piezoelectric element 21 of the recording head 3, and the lower electrode film 42 and the upper electrode film 43 are electrically connected to a voltage detecting circuit 45 (a kind of detecting unit of the invention).

The voltage detecting circuit 45 includes an integrating circuit 47 for integrating and outputting a voltage signal between the upper electrode film 43 and the lower electrode film 42, a inverting amplifier circuit 48 for inverting and amplifying the signal output from the integrating circuit 47 and outputting the amplified signal, and an A/D conversion circuit 49 for A/D converting the signal output from the inverting amplifier circuit 48 and outputting the converted signal to the controller 8. The integrating circuit 47 integrates a voltage variation due to the piezoelectric effect of the piezoelectric element 34 to which pressure is applied by a plurality of ink droplets P landing onto the vibration plate 33 and outputs a larger voltage variation. The inverting amplifier circuit 48 inverts the sign of the voltage variation, amplifies the signal output from the integrating circuit with a predetermined amplification ratio, and outputs the amplified signal. The A/D conversion circuit 49 converts the analog signal output from the inverting amplifier circuit 48 into a digital signal and outputs the converted digital signal to the controller 8 as a detection signal.

In the inspection device 15 for the liquid ejecting head having the above configuration, the center of the vibration plate 33 exposed on the bottom of the opened chambers 40 is arranged at the position opposite to the nozzle openings 16 of the recording head 3. That is, the inspection device 15 for the liquid ejecting head is mounted in a state of facing the opposite direction of the recording head 3 while exposing the vibration plate 33 through the opened chambers 40. In detail, it is preferable that the longitudinal direction center of the piezoelectric element 34 and the nozzle openings 16 are arranged to be opposite to each other with the vibration plate 33 interposed therebetween and the ink droplets P ejected from the recording head 3 are arranged so as to land onto the longitudinal direction center of the piezoelectric element 34. The nozzle openings 16 and the longitudinal direction center of the piezoelectric element 34 are relatively positioned such that the amplitude of the vibration plate 33 due to the ink droplets P landing can be increased, the voltage of the piezoelectric element 34 can be increased, and the landing inspection accuracy of the ink droplets P can be improved. In addition, the details of the positioning of the piezoelectric element 34 and the nozzle openings 16 will be described later.

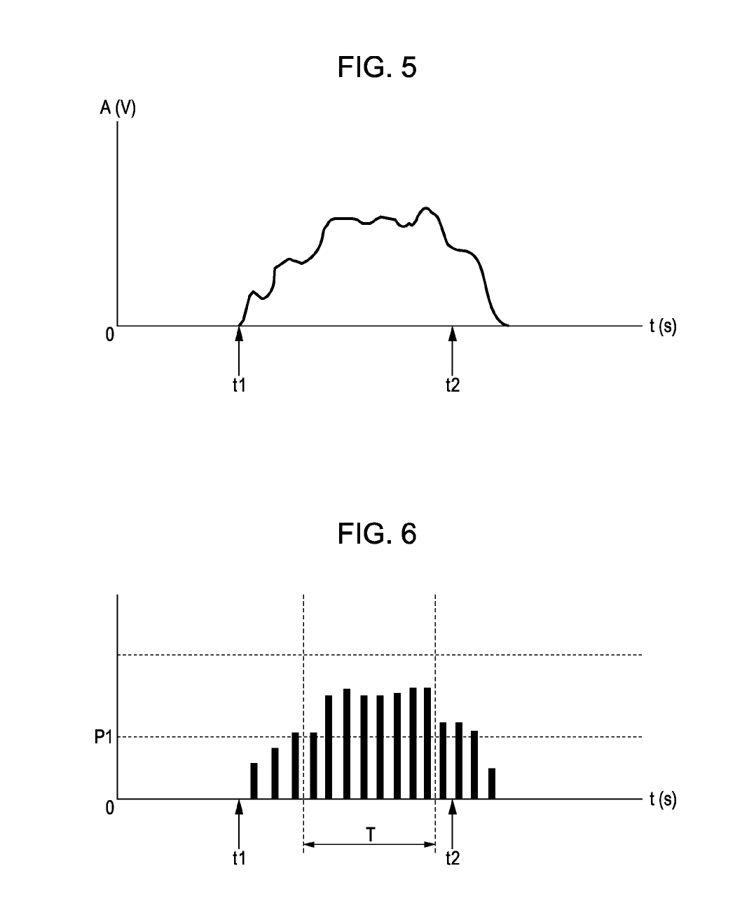

FIG. 5 is a view showing a voltage variation in the voltage detecting circuit, and FIG. 6 is a view showing a value obtained by A/D converting the voltage variation of FIG. 5.

When an inspection waveform (for example, about 43.2 KHz) is applied to the piezoelectric element 21 of the recording head 3 such that the ink droplets P are ejected to one nozzle opening 16 several times (for example, the amount of ink is about 6 pl and a flying speed is about 7 m/s) after the vibration plate 33 of the inspection device 15 for the liquid ejecting head and the nozzle openings 16 of the recording head 3 are positioned with high accuracy, the ejected ink droplets P land on the vibration plate 33. In this way, the vibration plate 33 is vertically vibrated and deformed and thus the piezoelectric element 34 is bent (for example, with an amplitude of about 400 nm). The inspection for the ejection of each of the nozzle openings 16 configuring the nozzle arrays 22 may be sequentially performed with respect to each of the nozzle arrays 22 (22Y, 22LM, 22M, 22LC, 22C and 22BK) corresponding to the inks of the respective colors or the inspection for the ejection of the nozzle openings 16 of the plurality of nozzle arrays 22 may be simultaneously performed.

The voltage detecting circuit 45 detects the voltage (for example, a maximum of about 12 V) generated between the electrodes 27 and 29 of the piezoelectric element 34 and accumulates the detected signal in the controller 8 as the inspected result from the inspection device 15 for the liquid ejecting head. The controller 8 functions as an amplitude acquiring unit and acquires the received detected signal as the amplitude of the detected signal. The controller 8 determines whether the ink droplets P are normally ejected from the nozzle openings 16 based on the amplitude (detected voltage) of the detected signal. For example, it may be determined whether the ink droplets P are normally ejected from the nozzle openings 16, depending on whether the average value of the amplitude of the detected signal in a period (denoted by a reference numeral T in FIG. 6) from the ejection start (denoted by a reference numeral t1 in FIGS. 5 and 6) of the ink droplets P to the ejection end (denoted by a reference numeral t2 in FIGS. 5 and 6) is less than a predetermined threshold value (denoted by a reference numeral P1 in FIG. 6). Accordingly, it is possible to improve the reliability of the inspection of the ejection of the ink droplets P using the inspection device 15 for the liquid ejecting head. With respect to the nozzle openings 16 which are determined to be not normally ejecting the ink droplets, a recovery treatment such as flushing, cleaning, or the like, is performed, the thickened ink is removed, and the mixed air bubbles are removed, thereby recovering the function.

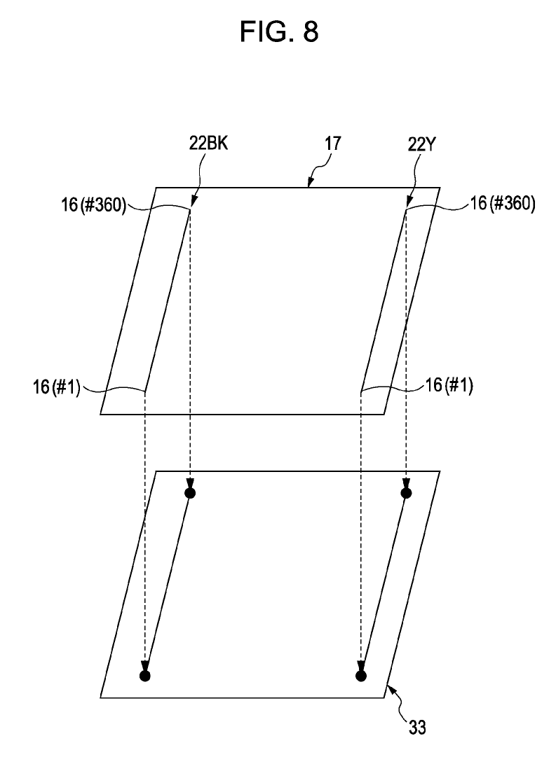

Now, the positioning of the nozzle plate 17 of the recording head 3 of the invention and the vibration plate 33 of the inspection device 15 for the liquid ejecting head will be described. FIG. 7 is a plan view of the nozzle plate 17, and FIG. 8 is an explanatory view explaining the positioning of the nozzle plate 17 and the vibration plate 33. First, the nozzle plate 17 of the recording head 3 and the vibration plate of the inspection device 15 for the liquid ejecting head are temporarily fixed in a state of facing each other. As nozzle arrays 22Y and 22LM located at both ends of the nozzle arrays 22, a total of four nozzle openings 16#1 and 16#360 located at both ends of the arrangement direction of the nozzle arrays 22Y and 22LM out of the nozzle openings 16 (#1 to #360) of the two nozzle arrays 22Y and 22LM is set to reference nozzles and the inspection device 15 for the liquid ejecting head is positioned while ejecting the ink droplets P toward the inspection device 15 for the liquid ejecting head from the total of four nozzle openings 16#1 and 16#360 of the nozzle arrays 22Y and 22LM, such that the inspection for the positioning of the recording head 3 and the inspection device 15 for the liquid ejecting head is performed. If the ink droplets P ejected from the total of four nozzle openings 16#1 and 16#360 of the nozzle arrays 22Y and 22LM, which are used as the reference nozzles, are not detected, the positioning of the inspection device 15 for the liquid ejecting head and the ejection of the ink droplets P are performed again such that the nozzle plate 17 and the vibration plate 33 are positioned.

However, the invention is not limited to the above-described embodiment and may be variously modified based on the claims.

Although the ink droplets P are ejected from the nozzle openings 16 of the recording head 3 so as to perform the inspection for the positioning in the above-described embodiment, the invention is not limited thereto and an inspection ink obtained by mixing a minute amount of volatile surfactant, capable of keeping the surface tension of the nozzle openings 16, to pure water may be used as the ejected liquid. Accordingly, even when the landing position of the ink droplets P is shifted, the landed ink droplets P are volatilized and the component thereof can be prevented from remaining.

In addition, the vibration plate 33 and the piezoelectric element 34 which are vibrated by the landing of the ink droplets P have an inherent vibration period Ta. The recording head 3 is set such that the ink droplets P are ejected at a time interval being an integral multiple of the inherent vibration period Ta. In this way, since the amplitude of the vibration plate 33 due to the landing of the ink droplets P is amplified and the amplitude of the detected signal is amplified, it is possible to improve the inspection accuracy of the ink droplets P.

The recording head 3 is configured to eject yellow (Y), light magenta (LM), magenta (M), light cyan (LC), cyan (C) and black (BK). Among the inks of the respective colors, for example, inks of yellow (Y), magenta (M), cyan (C) and black (BK) are set to first inks, and light magenta (LM) and light cyan (LC), inks with a residue during drying per ink amount less than that of the first inks are set as second inks. The recording head 3 ejects the second inks so as to wash out the residue of the vibration plate 33, and then ejects the first inks toward the vibration plate 33 so as to detect the landing state of the first inks by the voltage detecting circuit 45, thereby suppressing the reduction of the landing accuracy of the ink droplets P by the residue of the vibration plate 33. By ejecting the second inks after the first inks are ejected, the landing state of the second inks can be detected by the voltage detecting circuit 45. By ejecting the second inks after the first inks are ejected, it is possible to suppress the adhesion of the residue included in the landed inks to the surface of the vibration plate and suppress the reduction of the landing detection accuracy of the ink droplets P.

Although the ink jet recording head is used in the above description, the invention is applicable to a liquid ejecting head for ejecting a liquid other than the ink. For example, the invention is applicable to a display manufacturing device for manufacturing a color filter of a liquid crystal display or the like, an electrode manufacturing device for forming electrodes of an organic Electro Luminescence (EL) display, a Field Emission Display (FED) and the like, a chip manufacturing device for manufacturing biochips (biochemical elements, and the like).

What is claimed is:

1. An inspection device for a liquid ejecting head comprising:
a first vibration plate which is positioned at a position opposite to the nozzle openings of the liquid ejecting head for ejecting a liquid from the nozzle openings such that the liquid ejected from the nozzle openings of the liquid ejecting head lands thereon;
a first piezoelectric element bonded to the first vibration plate; and
a detecting unit which is connected to the first piezoelectric element so as to detect an electrical variation of the first piezoelectric element,
wherein the detecting unit inspects the ejection state of the nozzle openings based on a voltage variation of the first piezoelectric element by the landing of the liquid onto the first vibration plate.

2. The inspection device for the liquid ejecting head according to claim 1, wherein:
the liquid ejecting head includes a second vibration plate partitioning at least a portion of pressure chambers communicating with the nozzle openings and a second piezoelectric element bonded to the second vibration plate,
the first vibration plate is configured by a vibration plate having the same structure as the second vibration plate, and
the first piezoelectric element is configured by a piezoelectric element having the same structure as the second piezoelectric element.

3. The inspection device for the liquid ejecting head according to claim 1, wherein:
the liquid ejecting head is configured such that a first liquid and a second liquid with a residue during drying less than that of the first liquid are ejected toward the first vibration plate, and
the first liquid is ejected after the second liquid is ejected toward the first vibration plate such that the landing state of the first liquid is detected by the detecting unit.

4. The inspection device for the liquid ejecting head according to claim 1, wherein:
the liquid ejecting head is configured such that a first liquid and a second liquid with a residue during drying less than that of the first liquid are ejected toward the first vibration plate, and
the second liquid is ejected after the first liquid is ejected.

5. The inspection device for the liquid ejecting head according to claim 1, wherein the liquid ejecting head ejects the liquid at a time interval being an integral multiple of an inherent vibration period of the first vibration plate and the first piezoelectric element.

6. The inspection device for the liquid ejecting head according to claim 1, wherein the detecting unit performs detection based on an average value of a voltage within a predetermined time while the liquid is ejected from the liquid ejecting head.
